(19) United States
(12) Patent Application Publication
(10) Pub. No.: US 2013/0247756 A1
(43) Pub. Date: Sep. 26, 2013

(54) UV-REARRANGED PIM-1 POLYMERIC MEMBRANES AND A PROCESS OF PREPARING THEREOF

(71) Applicant: NATIONAL UNIVERSITY OF SINGAPORE, Singapore (SG)

(72) Inventors: Fuyun Li, Singapore (SG); Youchang Xiao, Singapore (SG); Tai-Shung Neal Chung, Singapore (SG)

(73) Assignee: NATIONAL UNIVERSITY OF SINGAPORE, Singapore (SG)

(21) Appl. No.: 13/769,039

(22) Filed: Feb. 15, 2013

Related U.S. Application Data
(60) Provisional application No. 61/599,084, filed on Feb. 15, 2012.

(51) Int. Cl. B01D 67/00; B01D 71/58; B01D 53/22

(52) U.S. Cl. CPC B01D 67/009; B01D 53/228; B01D 71/58
USPC 95/45; 521/180; 521/50.5

(57) ABSTRACT

The present invention relates to UV-rearranged PIM-1 polymeric membranes that can be used for advanced hydrogen purification and production. The present invention also relates to a process of preparing UV-rearranged PIM-1 polymeric membranes. The present invention further relates to a method of separating gas mixtures using the UV-rearranged PIM-1 polymeric membranes of the present invention.

### CROSS REFERENCE TO RELATED APPLICATIONS

This application claims priority to and is a non-provisional conversion of U.S. Provisional Patent Application Ser. No. 61/599,084, entitled “UV-Rearranged PIM-1 Polymeric Membranes For Advanced Hydrogen Purification and Production” filed on 15 Feb. 2012, which is incorporated herein by reference in its entirety.

### FIELD OF THE TECHNOLOGY

The field of the present technology generally relates to polymeric membranes and more specifically relates to UV-rearranged PIM-1 membranes. The field of the present technology also relates to UV-rearranged PIM-1 membranes prepared using an ultraviolet (UV) irradiation process involving a 1,2-migration reaction, wherein the UV-rearranged PIM-1 membranes may be used for gas separation (i.e., H₂/CO₂ gas separation). The field of the present technology further relates to a method of separating gas mixtures using the UV-rearranged PIM-1 membranes.

### BACKGROUND

In terms of high energy efficiency, low capital cost, small footprint and ease of scale up, membrane technology is of significant advantage for industrial hydrogen purification, flue gas separation and CO₂ capture when compared to conventional gas separation methods such as amine absorption, pressure swing adsorption or cryogenic distillation. However, traditional polymeric membranes have several drawbacks including low permeation flux and low separation factor, uncertain long term performance and uncertain stability in harsh operating conditions such as high temperature and high pressure. Thus, the need for a larger selection of high performance polymeric materials and the need for improved high performance polymeric materials have made high performance polymeric materials a major focus of membrane scientists, especially with the immediate aims of both high permeability and high selectivity in gas separation.

Polymers of intrinsic microporosity (PIMs), a novel class of polymers, have emerged as a promising polymeric membrane material for gas separation since the middle of the last decade. The superior gas separation performance of PIMs in terms of high gas permeability and moderate-to-good gas-pair selectivity is mainly ascribed to the PIMs special ladder-type structure with contorted sites that prevent polymer chains from rotating and prevent efficient polymer chain packing. As a result, PIMs have unusually high free volumes and high surface areas. Among all the synthesized PIMs, PIM-1 has become one of the most well-known polymers of intrinsic microporosity for membrane gas separation. The un-modified PIM-1 membrane has demonstrated reasonably good gas permeation performance, which is close to or even higher than the Robeson's upper bound. However, the un-modified PIM-1 membrane has demonstrated moderate-to-good gas-pair selectivity.

Since both gas permeability and gas-pair selectivity are paramount in the selection of a polymeric membrane for industrial uses, and PIMs demonstrate high gas permeability but moderate-to-good gas-pair selectivity, several studies have been conducted to post-modify the PIM-1 membrane to further enhance its gas transport properties primarily with respect to gas-pair selectivity. However, all these prior studies have focused on post-modifying nitrile groups of PIM-1 to either enhance the interaction with some specific gas molecules (i.e., CO₂) or induce a cross-linking reaction to tighten chain-to-chain spacing without interference of the spiro-carbon center and micro-pores.

As the inventors of the present disclosure understand, both micro-pores and ultra-fine pores exist in the PIM-1 polymer matrix. The micro-pores are mainly attributed to the loosely packed polymer chains that are a result of the kinked structure of PIM-1 at the spiro-carbon center and create a large free volume in the PIM-1 membrane; thus, the micro-pores contribute mostly to the high gas permeability of the PIM-1 membrane. The ultra-fine pores are a result of the efficient chain-to-chain spacing mainly at the site of nitrile groups and, thus, play a determining role in gas-pair selectivity. Consequently, the previous proposed modifications mainly modified the nitrile sites without disturbing the architecture of the spiro-carbon center and the micro-porous structure. On the other hand, such modifications would suggest that gas separation performance before and after the modifications may not be much different since the spiro-carbon induced contorted nature of the polymer matrix remains dominant and hinders the effect of modified-nitrile sites.

In Du et al., the nitrile groups of PIM-1 were converted to carboxyl groups via a simple post-modification hydrolysis reaction. The resultant hydrolyzed PIM-1 membrane demonstrated an evident decrease in gas permeability and an obvious increase in gas-pair selectivity. However, the overall gas separation performance still followed the upper bound line wherein the increase in gas-pair selectivity was at the expense of gas permeability. Later on, Du et al. incorporated CO₂-philic pendant tetrazole groups into a PIM-1 membrane by reacting nitrile groups of PIM-1 with sodium azide and made a significant enhancement in the gas permeation performance of the sodium azide modified PIM-1 membrane.

Recently, Mason et al. converted the original nitrile groups in PIM-1 to thioamide groups by using phosphorous pentasulfide as the thionating agent. It is expected that the introduction of thioamide groups would enhance the ability of polymer interaction with penetrant species, especially CO₂. In terms of gas transport properties, the modified thioamide-PIM-1 membrane showed an increased selectivity but a reduced permeability compared to the pristine original PIM-1 membrane.

In one of the inventors' previous works, the inventors molecularly designed the cavity size of a PIM-1 membrane by converting the nitrile groups of PIM-1 to triazine rings at an elevated temperature with a prolonged thermal soaking time. The resultant triazine ring modified PIM-1 membrane exhibited increases in both permeability and gas-pair selectivity with increasing thermal soaking time. This phenomenon was mainly due to a synergistic combination of a decrease in chain-to-chain spacing and an increase in inefficient packing of the PIM-1 polymer matrix during the cross-linking reaction. The triazine ring modified PIM-1 membrane thermally treated at 300° C. for 2 days had a CO₂ permeability of 4000 barrer and a CO₂/CH₄ and CO₂/N₂ ideal selectivity of 54.8 and 41.7, respectively, which were far beyond the Robeson's upper bounds.

In addition, the previous studies on modified PIM-1 membranes had never aimed at the separation of H₂ over CO₂ since an effective H₂/CO₂ diffusivity selectivity could not be realized due to the presence of excess free volume and large micro-pores created by the spiro-carbon center. In fact, the separation of H₂ and CO₂ by polymeric membranes is extremely troublesome because of the small size of H₂ and high condensability of CO₂. As a consequence, the counter balance between high H₂/CO₂ diffusivity selectivity and high CO₂/H₂ solubility selectivity results in most polymers having a relatively lower selectivity for the H₂ and CO₂ pair when compared to other gas pairs. Thus, PIM-1 membranes with a high H₂/CO₂ selectivity could only be feasible when the H₂/CO₂ diffusivity selectivity is maximized while the CO₂/H₂ solubility selectivity is maintained or minimized.

A need clearly exists to develop a PIM-1 membrane having both high permeability and high selectivity for medium-size gas pairs for advanced hydrogen purification and production.

### SUMMARY

PIM-1, one of the most well-known polymers of intrinsic microporosity for membrane gas separation, has been known for its super high permeability but average selectivity for medium-size gas pairs. PIM-1 has unimpressive selectivity for H₂ and CO₂ separation (i.e., a (H₂/CO₂)=0.7).

The inventors of the present disclosure have discovered that ultraviolet (UV)-rearranged polymers of PIM-1 membranes can be used for H₂/CO₂ separation with far superior separation performance compared to other polymeric membranes known in the art. For example, in embodiments, the PIM-1 membrane after UV radiation for 4 hours can show a H₂ permeability of about 452 barrer and a H₂/CO₂ selectivity of about 7.3. Experimental data and molecular simulation reveal that the polymer chains of PIM-1 can undergo a 1,2-migration reaction and be transformed to a close-to-planar like rearranged structure after UV radiation. As a result, the UV-irradiated PIM-1 membrane of the present disclosure can exhibit a considerable decrease in both the fractional free volume (FFV) and size of micro-pores. Nuclear magnetic resonance (NMR) and positron annihilation lifetime (PAL) results have been used to confirm the chemical and structural changes in PIM-1 after UV radiation, indicating that the decrease in both the FFV and size of micro-pores can be mainly ascribed to the destructed spiro-carbon center that results from the exposure to UV radiation.

In contrast to the unmodified PIM-1, the UV-irradiated PIM-1 membrane can exhibit exceptionally high gas separation performance that surpasses the upper bounds for gas pairs such as H₂/N₂, CO₂/CH₄ and H₂/CO₂. Sorption and x-ray diffraction (XRD) analyses indicate that the impressive H₂/CO₂ selectivity can arise from the significantly enhanced diffusivity selectivity induced by UV radiation, followed by molecular rearrangement, conformation change and more efficient polymer chain packing. The UV-irradiated PIM-1 can exhibit better polymer chain packing and a smaller fractional free volume (FFV) compared to the unmodified PIM-1. In addition, compared to pure gas tests, the UV-irradiated PIM-1 membrane can exhibit stable and comparable separation performance in mixed gas tests with and without the presence of CO. Therefore, the newly discovered UV-rearranged PIM-1 membrane may have great potential for the purification and production of industrial hydrogen.

A first aspect of the present disclosure provides a material including a monomer, wherein the monomer can include the formula:

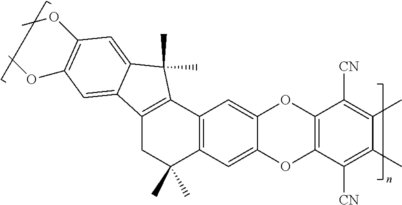

In embodiments, the material of the present disclosure can include a membrane, wherein the membrane can include the monomer having the formula described above. In embodiments, the membrane can be a UV-irradiated or UV-rearranged PIM-1 membrane.

In embodiments, the material of the present disclosure can include one or more membranes, wherein the one or more membranes can include the monomer having the formula described above. In embodiments, the one or more membranes can include or be UV-irradiated or UV-rearranged PIM-1 membranes.

In embodiments, the material of the present disclosure can be used for separation of gas mixtures such as H₂/CO₂, H₂/CO₂/CO, CO₂/CH₄, CO₂/CH₄/H₂S, H₂/N₂ or O₂/N₂.

In embodiments, the material of the present disclosure can be used for separation of gas mixtures such as H₂/CO₂, H₂/CO₂/CO, CO₂/CH₄, CO₂/CH₄/H₂S, H₂/N₂, O₂/N₂ or a combination thereof.

A second aspect of the present disclosure provides a process of preparing the material of the present disclosure, wherein the process can include: (a) providing an organic polymeric material containing a micro-porous structure and polymer chains; (b) performing ultraviolet (UV) irradiation on the organic polymeric material to form a UV irradiated organic polymeric material.

In embodiments, the process of the present disclosure can include: (c) performing a homolytic cleavage reaction on intra-molecular C—H bonds of the UV irradiated organic polymeric material, intermolecular C—H bonds of the UV irradiated organic polymeric material or a combination thereof.

In embodiments, the process of preparing the material of the present disclosure can include: (a) providing an organic polymeric material containing a micro-porous structure and polymer chains, wherein the organic polymeric material can include one or more membrane films; (b) performing ultraviolet (UV) irradiation on the organic polymeric material to form a UV-irradiated organic polymeric material, and wherein the UV irradiation can be performed by sandwiching the one or more membrane films of the organic polymeric material in between two quartz plates; and (c) performing a homolytic cleavage reaction on intra-molecular C—H bonds of the UV irradiated organic polymeric material, intermolecular C—H bonds of the UV irradiated organic polymeric material or a combination thereof.

In embodiments, the process of the present disclosure can include wherein the micro-porous structure of the organic polymeric material includes large micro-pores and ultrafine micro-pores, wherein the large micro-pores are due to the contorted or rigid nature of the organic polymeric material.

In embodiments, the process of the present disclosure can include wherein the micro-porous structure of the organic polymeric material can consist essentially of both large micro-pores and ultrafine micro-pores. In embodiments, the large micro-pores can be mainly ascribed to the contorted or rigid nature of the organic polymeric material.

In embodiments, the process of the present disclosure can include wherein the micro-porous structure of the organic polymeric material can be essentially destructed with respect to the large micro-pores, which can result in both the rearrangement of polymer chains and efficient polymer chain packing.

In embodiments, the process of the present disclosure can include destructing the micro-porous structure of the organic polymeric material with respect to the large micro-pores and rearranging the polymer chains of the organic material, wherein the destructing of the micro-porous structure and the rearranging of the polymer chains results in efficient polymer chain packing and the formation of a rearranged organic polymeric material.

In embodiments, the process of the present disclosure can include wherein the UV irradiation can be provided by a UV wavelength of about 254 nm for a period of one or more minutes to one or more hours, for instance, for a period of about 10 minutes to about 4 hours.

In embodiments, the process of the present disclosure can include wherein the UV irradiation can be provided for about 10 minutes, about 20 minutes, about 30 minutes, about 1 hour, about 2 hours, or about 4 hours.

In embodiments, the process of the present disclosure can include wherein the homolytic cleavage reaction can be provided by a 1,2-migration reaction to form a cyclohexyl ring.

In embodiments, the process of the present disclosure can include wherein the destruction of the microporous structure of the organic polymeric material and the formation of the rearranged organic polymeric material can include the reaction formula:

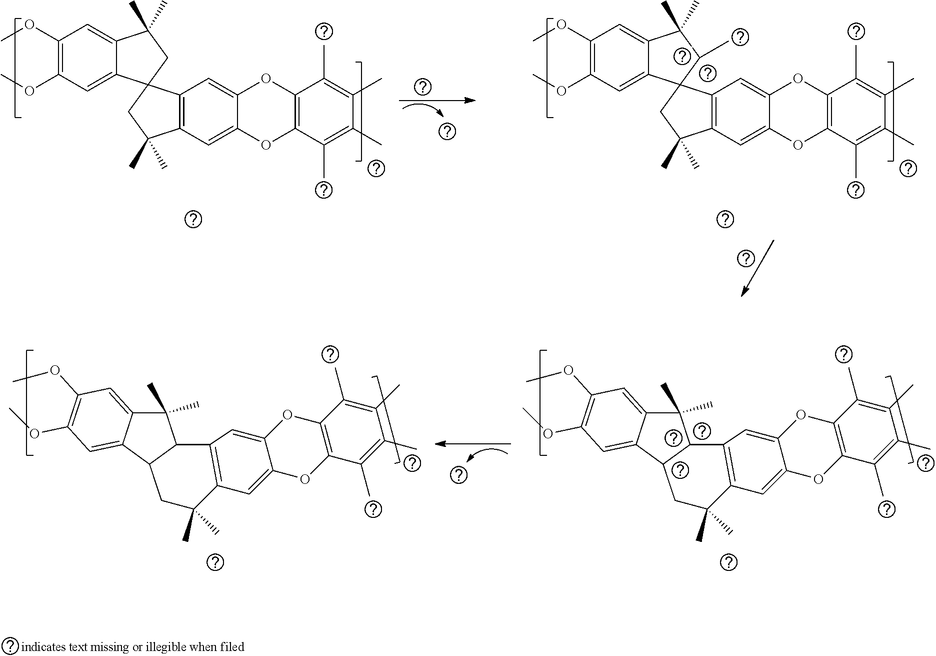

In embodiments, the process of the present disclosure can include wherein the destruction of the micro-porous structure of the organic polymeric material the formation of the rearranged organic polymeric material can consist of the reaction formula:

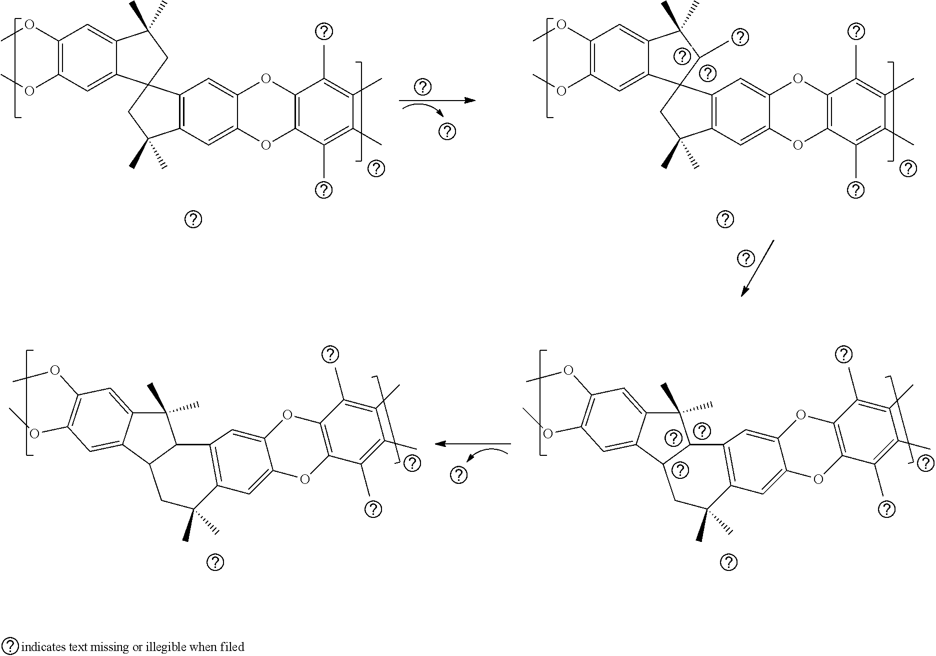

A third aspect of the present disclosure provides a method of separating a gas mixture, wherein the method includes: providing the material of the present disclosure described above and contacting the gas mixture with the material of the present disclosure.

In embodiments, the method of separating a gas mixture can include providing the material of the present disclosure described above and directing a gas mixture through the material of the present disclosure.

In embodiments, the material of the present disclosure can include one or more UV-irradiated or UV-rearranged PIM-1 membranes.

In embodiments, the method of separating a gas mixture can include providing one or more UV-irradiated or UV-rearranged PIM-1 membranes of the present disclosure and directing a gas mixture through the one or more UV-irradiated or UV-rearranged PIM-1 membranes of the present disclosure.

In embodiments, the method of separating a gas mixture can include providing one or more UV-irradiated or UV-rearranged PIM-1 membranes of the present disclosure and contacting a gas mixture with the one or more UV-irradiated or UV-rearranged PIM-1 membranes of the present disclosure.

In embodiments, the gas mixture can include H₂/CO₂, H₂/CO₂/CO, CO₂/CH₄, CO₂/CH₄/H₂S, H₂/N₂, O₂/N₂ or a combination thereof.

### BRIEF DESCRIPTION OF THE DRAWINGS

Embodiments of the present disclosure are described herein with reference to the drawings in which:

FIG. 1 illustrates an embodiment of a synthesis route of PIM-1.

FIG. 2 illustrates an embodiment of a reaction mechanism for the photochemical reaction of a PIM-1 membrane to form an embodiment of a UV-irradiated PIM-1 membrane of the present disclosure.

FIG. 3 illustrates the x-ray diffraction (XRD) analysis of the original PIM-1 membrane and embodiments of UV-irradiated PIM-1 membranes of the present disclosure.

FIG. 4 illustrates the effect of UV-irradiation time on the relative permeability (P/Po) for various gases, wherein the lines connected between data points are for eye-guide purposes.

FIG. 5 illustrates the positron annihilation lifetime (PAL) analysis of the original PIM-1 membrane and embodiments of UV-rearranged PIM-1 membranes of the present disclosure.

FIG. 6 illustrates simulated amorphous cells of (a) the original PIM-1 membrane and (b) an embodiment of a UV-rearranged PIM-1 membrane (in this case PIM-UV4hr) of the present disclosure (grey: Van der Waals surface; dark grey: Connolly surface with probe radius of 1.45 Å).

FIG. 7 illustrates the gas permeability of the original PIM-1 membrane and an embodiment of a UV-rearranged PIM-1 membrane (in this case PIM-UV4hr) of the present disclosure as a function of gas kinetic diameter and critical temperature.

FIG. 8 illustrates the effect of UV-irradiation time on gas-pair selectivity, wherein the lines connected between data points are for eye-guide purposes.

FIG. 9 illustrates an upper bound comparison of gas separation with respect to the gas mixtures of H₂/N₂, O₂/N₂, CO₂/CH₄ and H₂/CO₂ for: the original PIM-1 membrane, embodiments of UV-rearranged PIM-1 membranes of the present disclosure, Poly(imidesiloxane) copolymer, Polysulfone/zeolite 3A MMM, 6FDA-NDA-PDA (90 min), and PBI/ZIF-7 MMM.

FIG. 10 illustrates the aging behaviour of the original PIM-1 membrane and an embodiment of a UV-rearranged PIM-1 membrane (in this case PIM-UV4hr) of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented herein.

Unless specified otherwise, the terms “comprising” and “comprise” as used herein, and grammatical variants thereof, are intended to represent “open” or “inclusive” language such that they include recited elements but also permit inclusion of additional, un-recited elements.

As used herein, the term “about”, in the context of concentrations of components, conditions, other measurement values, etc., means +/−5% of the stated value, or +/−4% of the stated value, or +/−3% of the stated value, or +/−2% of the stated value, or +/−1% of the stated value, or +/−0.5% of the stated value, or +/−0% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used herein, the term “UV-rearranged PIM-1” includes “UV-irradiated PIM-1” unless specified otherwise.

As used herein, the term “UV-irradiated PIM-1” includes “UV-rearranged PIM-1” unless specified otherwise.

In accordance with the present disclosure, an advantage of the present disclosure over prior studies is the direct alteration of the spiro-carbon center of PIM-1 in order to maximize the effect of conformational change in the PIM-1 backbone. Weakening the spiro-carbon center can result in considerable decreases in both fractional free volume (FFV) and the pore radius of micro-pores and, thus, can significantly decrease gas permeability.

The present disclosure discusses: the use of UV irradiation to molecularly design the cavity size of PIM-1 membranes; the changes in the fractional free volume and structural conformation of UV-irradiated PIM-1 membranes; the gas separation mechanism exhibited by UV-irradiated PIM-1 membranes; and the relationship between a series of gas pair separations and the duration of UV irradiation of PIM-1 membranes. To the best of the inventors' knowledge, no one has published any PIM-related works for the separation of H₂ over CO_{2.}

In accordance with the present disclosure, a UV irradiation treatment can induce a direct alteration on the spiro-carbon center of PIM-1 thereby maximizing the effect of conformational change in PIM-1. The cavity size of the UV-irradiated PIM-1 membrane can be well tuned in order to straightforwardly amplify the effect of H₂/CO₂ diffusivity selectivity and enhance the overall H₂/CO₂ selectivity. To the best of the inventors' knowledge, the H₂/CO₂ gas separation performance of the UV-irradiated PIM-1 membrane or UV-rearranged PIM-1 membrane of the present disclosure may be the best compared to all known polymeric membranes.

The UV irradiation process will be discussed in detail to elucidate the reaction mechanism. In addition to conducting binary mixed gas tests, a small amount of carbon monoxide (CO) can also be included in tertiary mixed gas tests with the aim of potential industrial applications of the UV-rearranged PIM-1 membranes for H₂ purification and production.

Structural Determination of the UV-Irradiated PIM-1 Membrane

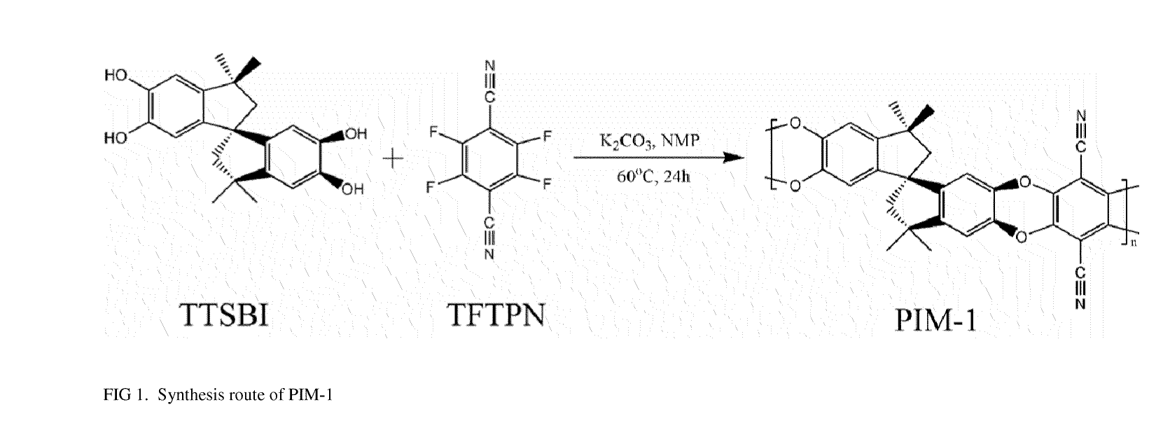

FIG. 1 illustrates an embodiment of a synthesis route of PIM-1. In embodiments, synthesis of PIM-1 can be based on the polycondensation of 2,3,5,6-tetrafluoroterephthalonitrile (TFTPN) with 5,5′,6,6′-tetrahydroxy-3,3,3′,3′-tetramethyl-1,1′-spirobisindane (TTSBI) in accordance with the reaction scheme described in FIG. 1.

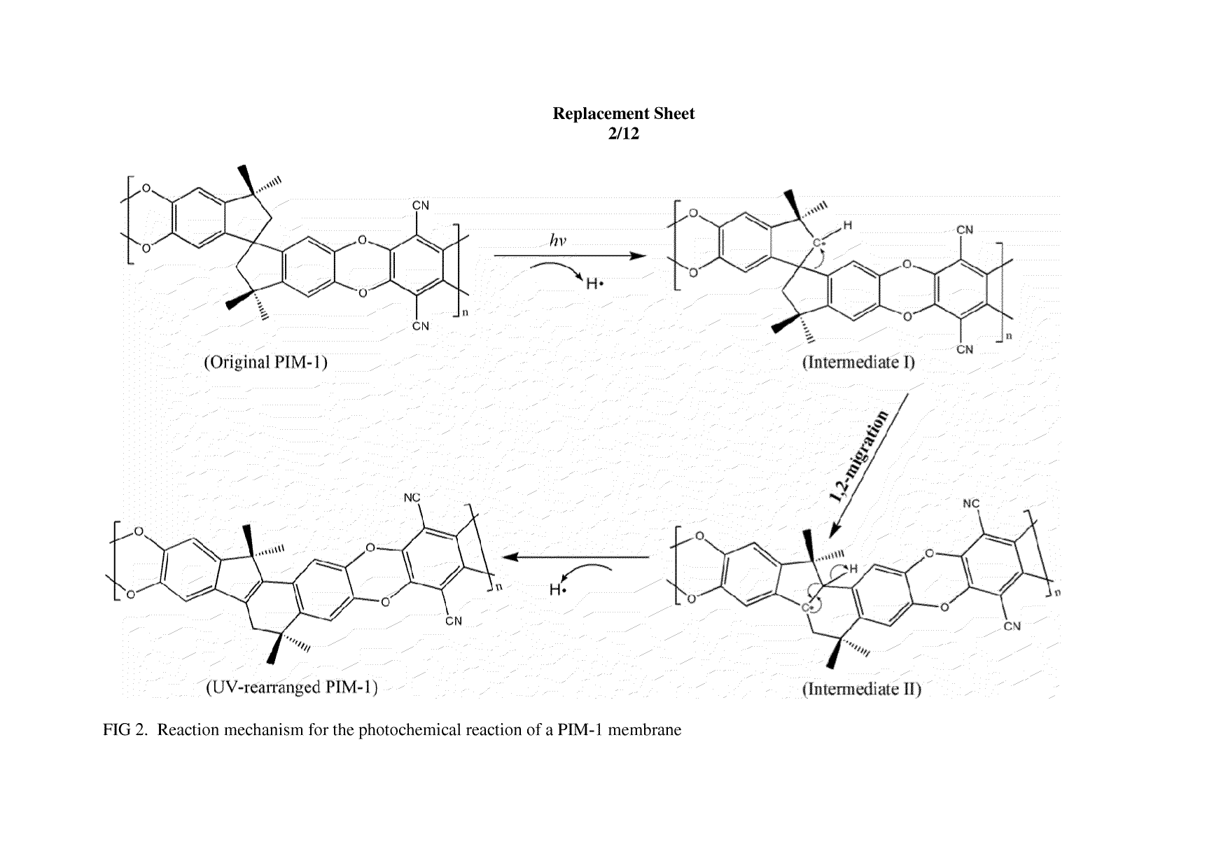

FIG. 2 illustrates an embodiment of a photochemical reaction mechanism of a PIM-1 membrane. The C—H containing PIM-1 membrane can undergo homolytic cleavage with the exposure to UV irradiation. The polymer chains of PIM-1 can undergo an intra-molecular 1,2-migration reaction to break C—H covalent bonds.

Generally, the selectivity of C—H in the 1,2-migration reaction can follow the reaction pattern of tertiary>secondary>primary C—H bonds. Thus, the expected reaction sites of alkyl groups in PIM-1 can be in the order of ═CH— in the phenyl groups, then to >CH₂ and —CH₃. However, due to the highly conjugated π-electrons in the benzene rings, the C—H bonds of the phenyl groups are not easily attacked by ultraviolet energy. Therefore, in embodiments, the reaction site can be at the >CH₂ group.

According to FIG. 2, under UV irradiation, the originally covalently bonded >CH2 group can break up, release one hydrogen atom and form a radical-ion intermediate (i.e., Intermediate I). Due to the influence of the nearby alkyl group, an intra-molecular 1,2-migration reaction can take place and form a cyclohexyl radical intermediate (i.e., Intermediate II). With the abstraction of another hydrogen atom in the reactive intermediate II, a more stable UV-rearranged PIM-1 can occur. As a result, the spiro-carbon center in the original PIM-1 can be destroyed with the formation of a cylcohexyl ring in the UV-rearranged PIM-1. The detailed characterization of the PIM-1 membranes before and after UV irradiation is provided herein.

In embodiments, one or more un-modified PIM-1 membranes can be exposed to UV irradiation for about 1 minute or more, about 5 minutes or more, about 10 minutes or more, about 30 minutes or more, about 1 hour or more, about 1.5 hours or more, about 2 hours or more, about 2.5 hours or more, about 3 hours or more, about 3.5 hours or more, or about 4 hours or more to form one or more UV-irradiated PIM-1 membranes of the present disclosure.

In embodiments, the one or more un-modified PIM-1 membranes can include one or more films. In embodiments, the one or more un-modified PIM-1 membranes can include one or more dense films. In embodiments, the one or more un-modified PIM-1 membranes can be hollow fiber membranes. In embodiments, the hollow fiber membrane or hollow fiber membranes can include a plurality of hollow fibers. In embodiments, the one or more un-modified PIM-1 membranes can be flat sheet membranes. In embodiments, the flat sheet membrane or flat sheet membranes can include one or more flat sheets.

Each of the one or more un-modified PIM-1 membranes can have a surface area. In embodiments, the entire or substantially the entire surface area of each of the one or more un-modified PIM-1 membranes can be irradiated upon exposure to UV light. In embodiments, the one or more un-modified PIM-1 membranes can have dimensions, including a surface area, that are suitable for separating gas mixtures.

In embodiments, a UV-rearranged PIM-1 membrane of the present disclosure can include one or more films. In embodiments, a UV-rearranged PIM-1 membrane of the present disclosure can include one or more dense films. In embodiments, a UV-rearranged PIM-1 membrane of the present disclosure can be a hollow fiber membrane. In embodiments, the hollow fiber membrane can include a plurality of hollow fibers. In embodiments, a UV-rearranged PIM-1 membrane of the present disclosure can be a flat sheet membrane. In embodiments, the flat sheet membrane can include one or more flat sheets.

In embodiments, UV-rearranged PIM-1 membranes of the present disclosure can be prepared on an industrial scale. Equipment suitable for preparing UV-rearranged PIM-1 membranes of the present disclosure on an industrial scale is contemplated.

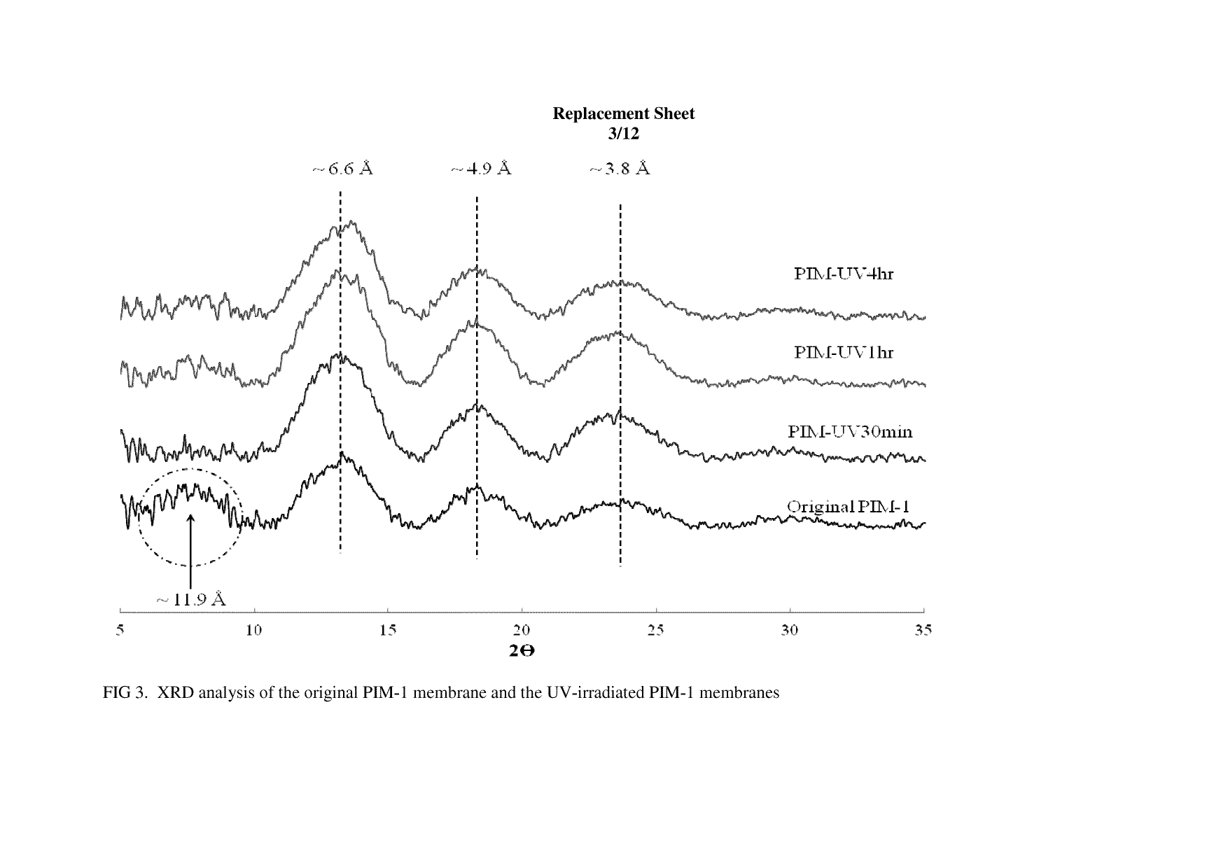

The destruction of the spiro-carbon center can have immediate effects on d-space and chain packing. XRD analyses can be performed to study the change in the interstitial space of the PIM-1 membranes or films before and after the UV irradiation process. FIG. 3 shows the results of XRD analyses of an original PIM-1 membrane (the un-modified PIM-1 membrane) and embodiments of a UV-irradiated PIM-1 membrane of the present disclosure including PIM-UV30min (30 minute UV-irradiated PIM-1 membrane), PIM-UV1hr (1 hour UV-irradiated PIM-1 membrane), and PIM-UV4hr (4 hour UV-irradiated PIM-1 membrane).

According to FIG. 3, several distinct amorphous peaks with the d-spaces ranging from about 3.8 to about 11.9 Å can be observed in all PIM-1 based membranes. This observation is consistent with other reported studies. Referring to the original PIM-1 membrane, the largest d-spacing of about 11.9 Å can represent the d-space between the adjacent spiro-carbons along a single chain. The peak at the angle of about 6.6 Å can be attributed to the loosely packed polymer chains due to the kinked nature in PIM-1 and this, on the other hand, also can induce the formation of micro-pores in the polymer matrix. This can be one of the main reasons that original PIM-1 membrane (i.e., un-modified PIM-1 membrane) has excess free volume and high gas permeability.

The middle peak, which has a d-space of about 4.9 Å can represent the d-space of efficiently packed polymer chain-to-chain distance and contributes directly to the conformation of ultra-fine pores. Comparing the UV-rearranged PIM-1 membranes with the original PIM-1 membrane, there can be a slight shift of the peak to the right at the d-spacing of about 6.6 A, especially for PIM-UV4hr, demonstrating that the UV-rearranged PIM-1 membranes can have better polymer chain packing and smaller micro-pores than the pristine original PIM-1 membrane. In addition, after the UV treatment, the peak with the highest d-spacing (i.e., about 11.9 Å) can become notably vague or can even disappear. This can be a direct result of the destruction of the spiro-carbon center during the UV irradiation process.

Accordingly, the UV rearrangement reaction can induce (1) destruction of the spiro-carbon center in the original PIM-1 backbone and/or (2) rearrangement of polymer chains toward efficient polymer chain packing. Both the destruction of the spiro-carbon center and the rearrangement of polymer chains can result in a decrease in FFV and/or micro-pore size.

Pure Gas Separation Performance

Table 1 shows the pure gas separation performance of an original PIM-1 membrane and the pure gas separation performance of embodiments of a UV-irradiated PIM-1 membrane of the present disclosure including: PIM-UV10min (10 minute UV-irradiated PIM-1 membrane); PIM-UV20min (20 minute UV-irradiated PIM-1 membrane); PIM-UV30min (30 minute UV-irradiated PIM-1 membrane); PIM-UV1hr (1 hour UV-irradiated PIM-1 membrane); PIM-UV2hr (2 hour UV-irradiated PIM-1 membrane); and PIM-UV4hr (4 hour UV-irradiated PIM-1 membrane).

TABLE 1
Pure gas separation performance of the original PIM-1 membrane
and UV-irradiated PIM-1 membranes at different UV irradiation times
(Tested at 35° C. and 3.5 atm)^{a)}

| | Permeability | | | | | | | | |
|---|---|---|---|---|---|---|---|---|---|
| | [Barrer]^{b)} | | | | | Ideal selectivity | | | |
| Membranes | H₂ | O₂ | N₂ | CH₄ | CO₂ | H₂/N₂ | O₂/N₂ | CO₂/CH₄ | H₂/CO₂ |
| Original PIM-1 | 3731 | 1172 | 309 | 431 | 6601 | 12.1 | 3.8 | 15.3 | 0.6 |
| PIM-UV10min | 3636 | 952 | 225 | 283 | 4560 | 16.2 | 4.2 | 16.1 | 0.8 |
| PIM-UV20min | 2818 | 416 | 73.6 | 62.1 | 1869 | 38.3 | 5.7 | 30.1 | 1.5 |
| PIM-UV30min | 2247 | 189 | 27.7 | 23.1 | 724 | 81.1 | 6.8 | 31.3 | 3.1 |
| PIM-UV1hr | 1488 | 97.8 | 14.9 | 13.2 | 348 | 99.9 | 6.6 | 26.4 | 4.3 |
| PIM-UV2hr | 553 | 30.9 | 4.9 | 4.7 | 118 | 112 | 6.3 | 25.1 | 4.7 |
| PIM-UV4hr | 452 | 16.5 | 2.7 | 2.6 | 61.9 | 166 | 6.1 | 23.7 | 7.3 |

^{a)}(All UV-treatment or UV-irradiation of PIM-1 membranes was carried out at a fixed UV distance of 2 cm and UV wavelength of 254 nm);
^{b)}1 Barrer = 1 × 10⁻¹⁰ cm³(STP) cm cm⁻² s⁻¹ cmHg⁻¹

According to Table 1, the original PIM-1 membrane can exhibit extremely high gas permeability and moderate selectivity for all gases, which is consistent with previously reported results. Referring to the UV-irradiated PIM-1 membranes, generally, the gas permeability decreases with increasing UV irradiation time. However, not all gases are affected to the same degree.

In embodiments, a UV-irradiated PIM-1 membrane of the present disclosure can have a H₂ permeability of 3636 barrer or less, 2818 barrer or less, 2247 barrer or less, 1488 barrer or less, 553 barrer or less, or 452 barrer or less.

In embodiments, a UV-irradiated PIM-1 membrane of the present disclosure can have a H₂/CO₂ selectivity of about 0.8 or more, about 1.5 or more, about 3.1 or more, about 4.3 or more, about 4.7 or more, or about 7.3 or more.

In embodiments, the UV-treatment or UV-irradiation of PIM-1 membranes can be performed using UV-generating equipment. In embodiments, the PIM-1 membranes can be sandwiched in between two quartz plates and kept a fixed UV distance away from a UV-bulb for a period of time. Other methods of performing UV-treatment or UV-irradiation are also contemplated.

In embodiments, UV-treatment or UV-irradiation of PIM-1 membranes can be carried out at a fixed UV distance of about 2 cm and UV wavelength of about 254 nm. In embodiments, UV-treatment or UV-irradiation can be carried out at a UV wavelength less than about 254 nm. In embodiments, UV-treatment or UV-irradiation can be carried out at a UV wavelength greater than about 254 nm. In embodiments, UV-treatment or UV-irradiation can be carried out at a UV distance of less than about 2 cm. In embodiments, UV-treatment or UV-irradiation can be carried out at a UV distance of greater than about 2 cm. In embodiments, UV distance and/or UV wavelength can be variable (i.e., are not fixed) during UV-treatment or UV-irradiation.

In embodiments, UV-treatment or UV-irradiation of PIM-1 membranes can be carried out for about 1 minute or more, about 5 minutes or more, about 10 minutes or more, about 30 minutes or more, about 1 hour or more, about 1.5 hours or more, about 2 hours or more, about 2.5 hours or more, about 3 hours or more, about 3.5 hours or more, or about 4 hours or more.

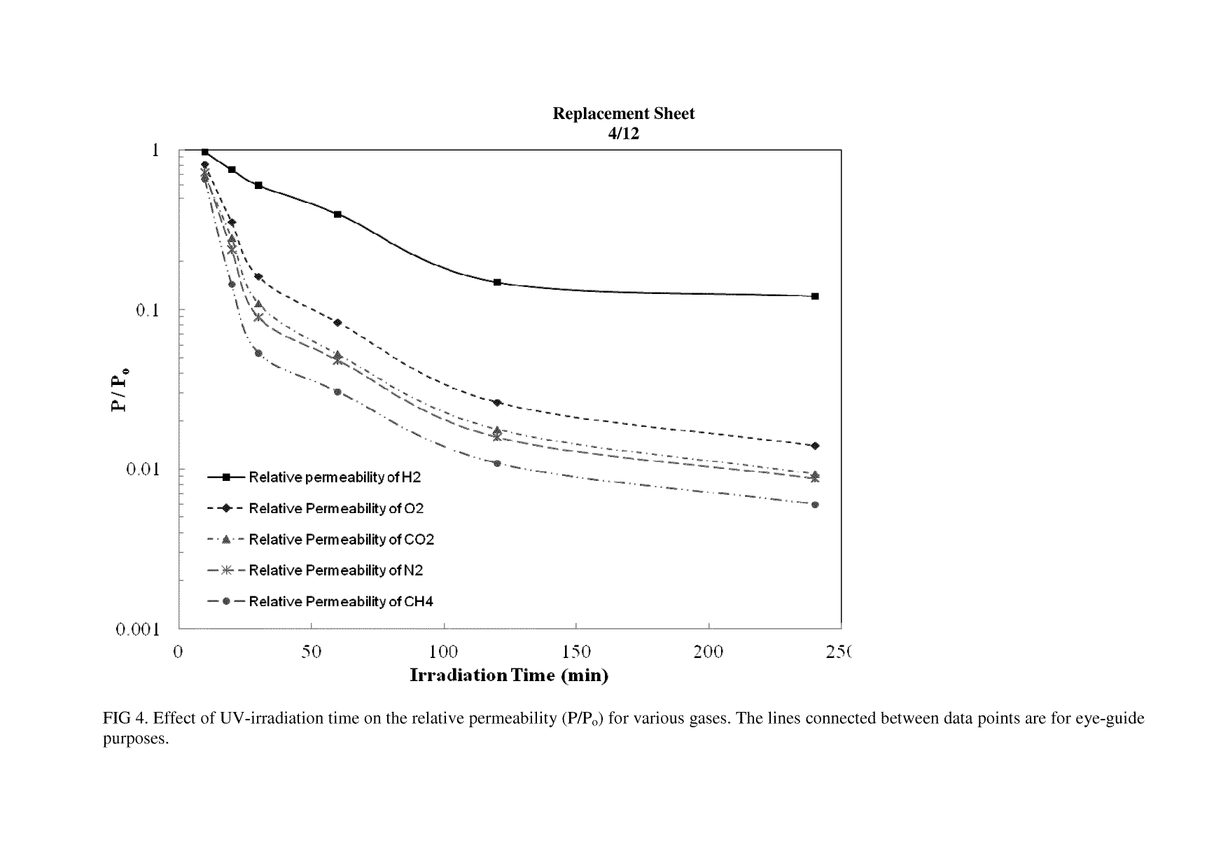

FIG. 4 illustrates the effect of UV-irradiation time on the relative permeability (P/Po) for various gases. FIG. 4 shows the relative permeability P/Pₒ, where Pₒ is the permeability of the pristine original PIM-1, as a function of irradiation time.

As can be seen in FIG. 4, for large molecules such as O₂, CO₂, N₂ and CH₄, P/Pₒ can decline sharply with the irradiation time at the beginning, and can tend to level off after 30 minutes of irradiation. On the other hand, H₂ can exhibit a relatively smaller decrease in permeability over the entire irradiation period. The largest permeability reduction in P/Pₒ can be seen for CH₄. The extent of permeability reduction follows a trend that can be related to the penetrant size of gas molecules. The larger the gas molecule, the faster the permeability decreases with increasing UV irradiation duration. In accordance with the present disclosure, the diffusivity coefficient can have a large impact on gas permeability as the diffusivity ability in the PIM-1 polymer matrix can be very much affected by the penetrant size of gas molecules.

Sorption studies were carried out on selected membranes to verify that the diffusivity coefficient can have a large impact on gas permeability and the results are shown in Table 2. Sorption studies were carried out on an original PIM-1 membrane and embodiments of a UV-irradiated PIM-1 membrane of the present disclosure including PIM-UV30min (30 minute UV-irradiated PIM-1 membrane), PIM-UV1hr (1 hour UV-irradiated PIM-1 membrane), and PIM-UV4hr (4 hour UV-irradiated PIM-1 membrane).

TABLE 2
Sorption results of the original PIM-1 membrane and the
UV-irradiated PIM-1 membranes (Tested at 35° C.).

| | | | | | | | Selectivity | | |
|---|---|---|---|---|---|---|---|---|---|
| | CH₄ | | | CO₂ | | | S_{CO2}/ | D_{CO2}/ | P_{CO2}/ |
| Membranes | P^{a)} | S^{b)} | D^{c)} | P^{a)} | S^{b)} | D^{c)} | S_{CH4} | D_{CH4} | P_{CH4} |
| Original PIM-1 | 431.0 | 79.2 | 5.4 | 6601.0 | 212.2 | 31.1 | 2.7 | 5.7 | 15.3 |
| PIM-UV30min | 23.1 | 76.8 | 0.3 | 724.0 | 211.0 | 3.4 | 2.7 | 11.4 | 31.3 |
| PIM-UV1hr | 13.2 | 75.8 | 0.2 | 348.0 | 210.0 | 1.7 | 2.8 | 9.5 | 26.4 |
| PIM-UV4hr | 2.6 | 77.4 | 0.03 | 61.9 | 216.5 | 0.3 | 2.8 | 8.5 | 23.8 |

^{a)}(P: Barrer = 1 × 10⁻¹⁰ cm³(STP)cm cm⁻² s⁻¹ cmHg⁻¹);
^{b)}(S: = 1 × 10⁻³ cm³ (STP)cm⁻³cmHg⁻¹)
^{c)}(D: = 1 × 10⁻⁷ cm²s⁻¹)

As shown in Table 2, the solubility coefficients (S) can remain fairly constant while the diffusivity coefficients (D) can decrease considerably with the UV irradiation time. For example, in the CO₂ sorption studies, the diffusivity coefficient can decrease more than 100 times from the pristine original PIM-1 membrane to 0.3×10⁻⁷ cm²s⁻¹ after a UV irradiation time of 4 hr. Thus, in accordance with the present disclosure, the decrease in diffusivity coefficient can greatly contribute to the reduction in gas permeability.

In accordance with the present disclosure, the decrease in gas permeability exhibited in the UV-irradiated PIM-1 membranes can be caused by the shrinkage of large micro-pores (due to the destruction of the spiro-carbon center) in the PIM-1 polymer matrix since the large micro-pores can have a great impact with respect to the high gas permeability in the original PIM-1 membrane. As a result, the decrease in gas permeability in the UV-irradiated PIM-1 membranes of the present disclosure (i.e., especially for large gas molecules) is much more pronounced than in other known PIM-1 based modified membranes. The UV-irradiated PIM-1 membranes of the present disclosure can have a smaller micro-pore size and/or smaller FFV compared to the pristine original PIM-1 membrane.

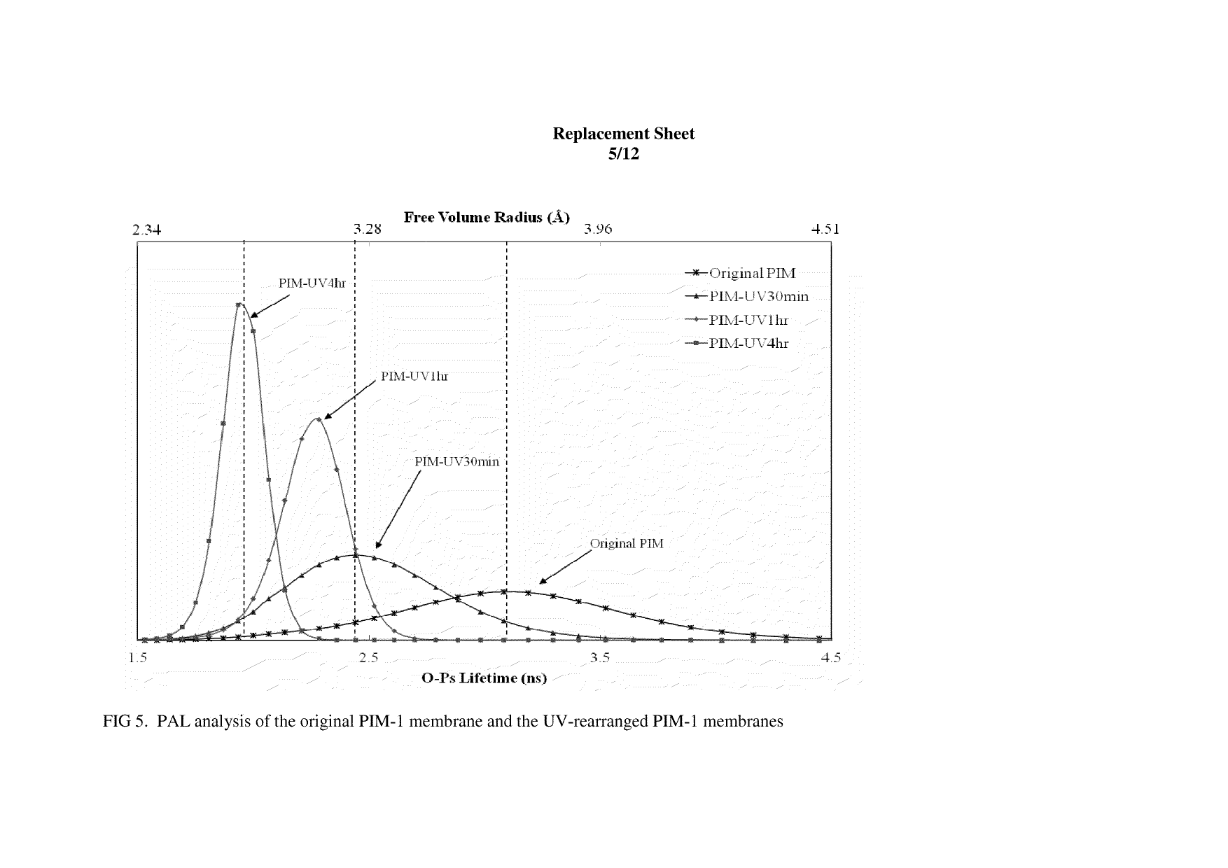

The reduction of pore size and FFV in the UV-irradiated membranes can be verified by PAL experiments as illustrated in FIG. 5. FIG. 5 depicts the free volume distributions of a pristine original PIM-1 membrane and embodiments of a UV-irradiated PIM-1 membrane of the present disclosure including PIM-UV30min (30 minute UV-irradiated PIM-1 membrane), PIM-UV1hr (1 hour UV-irradiated PIM-1 membrane), and PIM-UV4hr (4 hour UV-irradiated PIM-1 membrane) with the help of MELT analyses. The increase in UV irradiation duration can shift the peak to the left (i.e., demonstrating a decrease in o-Ps (ortho-Positronium) lifetime or a reduction in free volume radius) and can result in a relatively narrower free volume distribution. A comparison between the original PIM-1 membrane and the UV-treated PIM-UV4hr membrane can reveal a decrease of o-Ps lifetime from about 3.08 to about 1.93 ns while the corresponding free volume radius can dwindle from about 3.69 to about 2.79 Å. In accordance with the present disclosure, the sharpening or narrowing of free volume distribution with UV-irradiation time can enhance the size-exclusion ability of the UV-irradiated PIM-1 membranes and, thus, can increase overall gas-pair selectivity. In accordance with the present disclosure, besides the shrinkage in pore size, another immediate effect of the UV irradiation process or UV rearrangement process of the present disclosure can be a UV-irradiated PIM-1 membrane having a densified structure with a considerable decrease in FFV.

In accordance with the present disclosure, the reduction in overall FFV and pore size can be primarily ascribed to the decrease in micro-pores, which in turn can induce more efficient polymer chain packing after the 1,2-migration photochemical reaction. Molecular dynamics simulation can be used to simulate the PIM-1 polymer chain rearrangement and re-packing that can occur after the UV irradiation process.

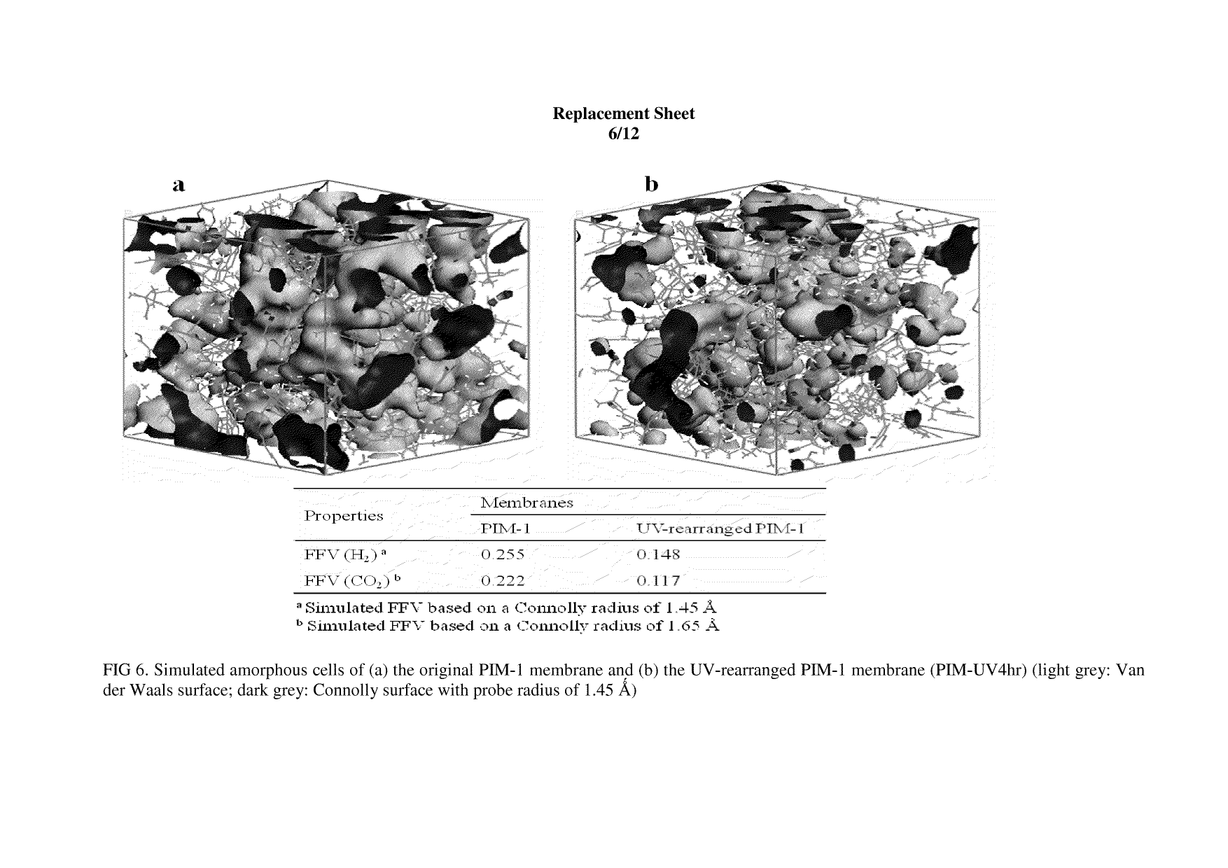

FIG. 6 illustrates simulated amorphous cells of an original PIM-1 membrane and a UV-rearranged PIM-1 membrane (in this case PIM-UV4hr) of the present disclosure. As shown in FIG. 6, in embodiments, the simulated FFV can show a considerable drop of FFV from about 0.255 to about 0.148 after the UV irradiation treatment when a Connolly radius of 1.45 Å is used (i.e., kinetic radius of H₂). Therefore, the UV-rearranged PIM-1 membranes of the present disclosure having a new close-to-planar polymer chain structure can have a smaller pore size and FFV than the original PIM-1 membrane matrix.

In comparing the gas permeability of the original PIM-1 membrane with the UV-irradiated PIM-1 membranes of the present disclosure, a noteworthy observation is that the original PIM-1 membrane exhibits a trend of P_{CO2}>P_{H2} and P_{CH4}>P_{N2}, whereas the UV-irradiated PIM-1 membranes or UV-rearranged PIM-1 membranes of the present disclosure can exhibit a reverse trend of P_{H2}>P_{CO2} and P_{N2}>P_{CH4}. This is closely related to the molecular properties of the permeating gases and the nature of permeation processes. In detail, gas permeability is a contribution of both the diffusivity coefficient and the solubility coefficient. The kinetic diameters of H₂ (dₖ=2.89 Å) and N₂ (dₖ=3.64 Å) molecules are smaller than CO₂ (dₖ=3.3 Å) and CH₄ (dₖ=3.8 Å) molecules, respectively, thus diffusion generally favors H₂ and N₂; however, CO₂ (T_{c}=304.2 K) and CH₄ (T_{c}=190.6 K) are more condensable than H₂ (T_{c}=33.2 K) and N₂ (T_{c}=126.2 K), and thus solubility generally favors CO₂ and CH₄.

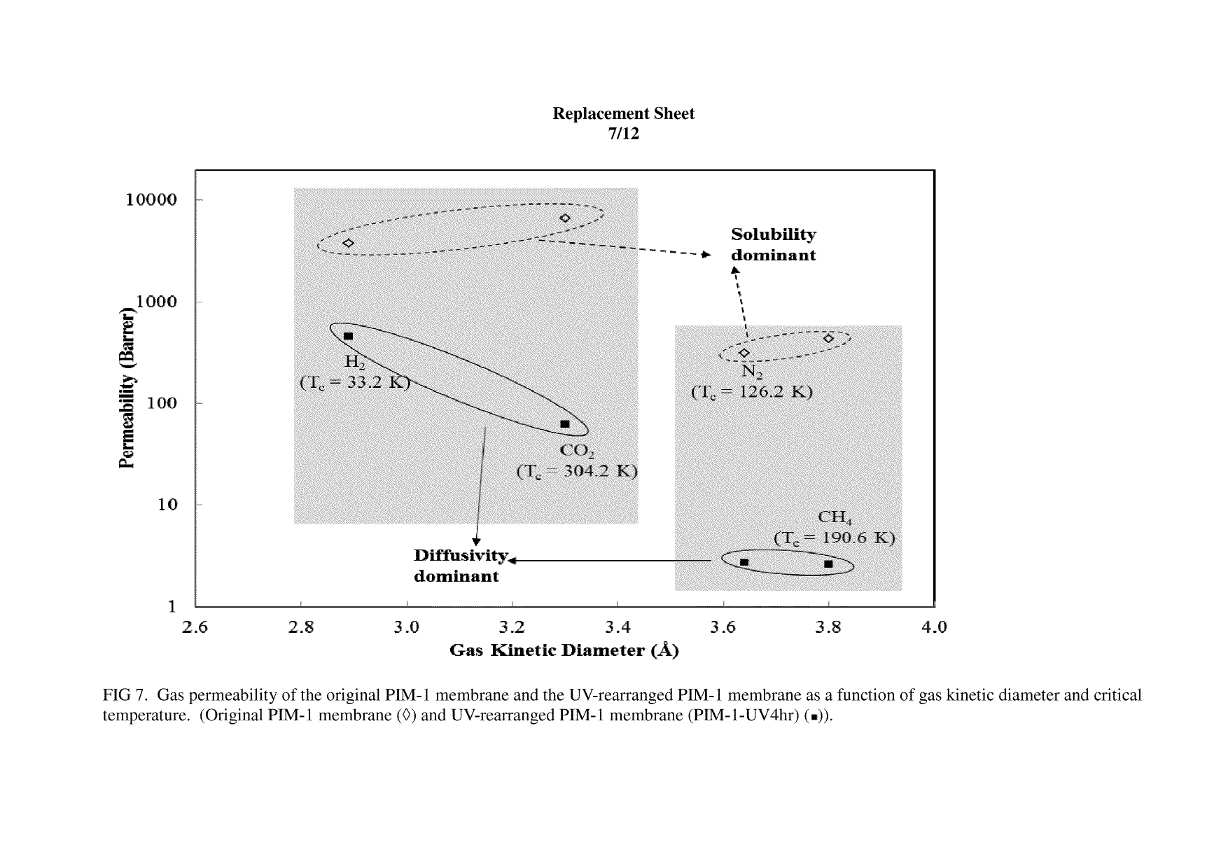

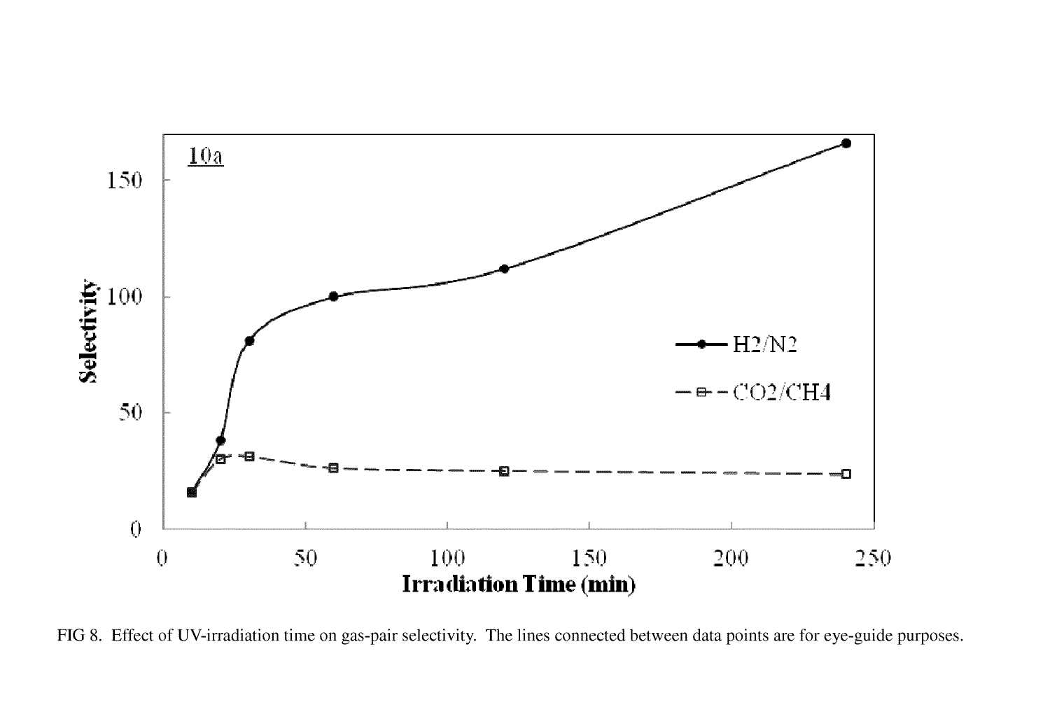

The detailed correlation of gas permeability of an original PIM-1 membrane and a UV-rearranged PIM-1 membrane (in this case PIM-UV4hr) of the present disclosure with gas kinetic diameters and their critical temperatures is plotted in FIG. 7. In the original PIM-1 membrane, CO₂ and CH₄ can permeate faster than H₂ and N₂, respectively, indicating that the solubility contribution is dominant due to the presence of the excess free volume in the original PIM-1 membrane. Whereas, in the UV-irradiated PIM-1 membrane (in this case PIM-UV4hr) of the present disclosure, H₂ and N₂ can permeate faster than CO₂ and CH₄, respectively, demonstrating that the diffusivity contribution to permeability can be greater than the solubility contribution. As a result, the PIM-1 membranes can turn from being originally CO₂ selective (i.e., CO₂/H₂) to H₂ selective (i.e., H₂/CO₂) after UV irradiation treatment. For example, the original PIM-1 membrane has a H₂/CO₂ selectivity of 0.6, whereas the H₂/CO₂ selectivity of the 4 hr UV-irradiated PIM-1 membrane is about 7.3.

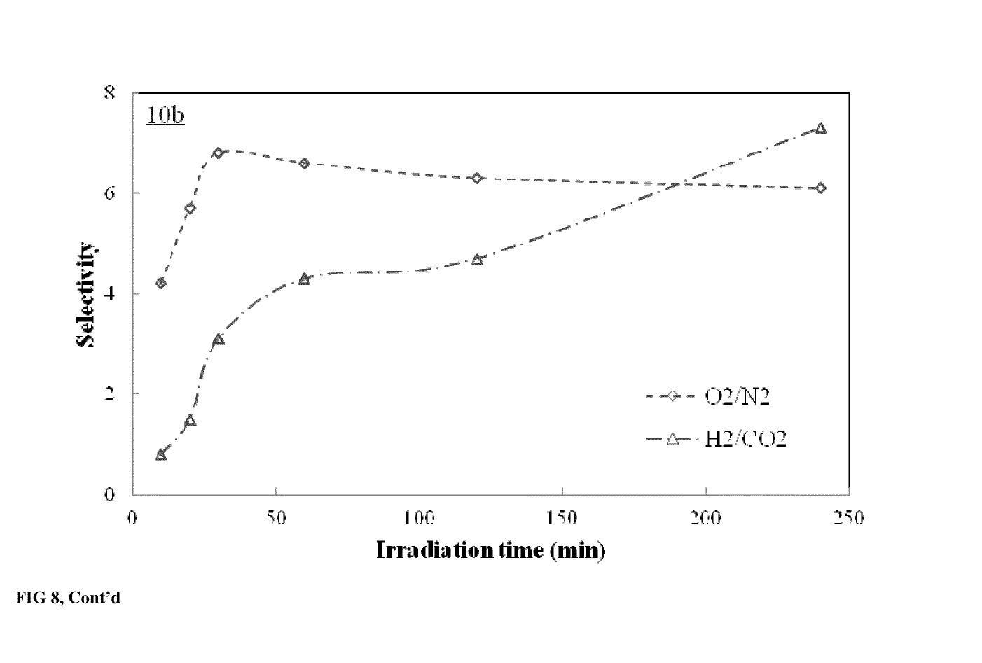

In accordance with the present disclosure, the increase in UV irradiation time can also alter the separation performance of different gas-pairs. FIG. 8 illustrates the effect of UV-irradiation time on gas-pair selectivity and plots various gas-pair selectivity against UV-irradiation time. According to FIG. 8, for O₂/N₂ and CO₂/CH₄, the highest selectivity can be observed for the PIM-1 membranes that have undergone 30 min of UV irradiation, and the selectivity for H₂/N₂ and H₂/CO₂ increases with increasing UV-irradiation time.

The gas-pair selectivity can be dependent on the diffusion ability of different gas penetrants. Initially, the high free volume and large pore size resulting from the contorted nature of the original PIM-1 membrane enables all gas molecules to diffuse through easily. As the UV-irradiation time increases, the replacement of the kinked structure with the newly formed close-to-planar PIM-1 polymer structure can result in the rearrangement of polymer chains and shrinkage of large micro-pores. As a consequence, in accordance with the present disclosure, both FFV and pore size of the UV-rearranged membrane can decrease with UV irradiation time.

In accordance with the present disclosure, at a point, the pore size in the UV-irradiated PIM-1 polymer matrix can reach an extent to clearly distinguish between two gas molecules, thus, enhancing the gas-pair selectivity (i.e., selectivity of O₂/N₂ and CO₂/CH₄ with under about 30 min of UV irradiation time). However, a prolonged UV irradiation time can further diminish FFV and pore size leading to a difficulty in diffusion of almost all large gas molecules (e.g., O₂, N₂, CO₂ and CH₄) thereby resulting in reduced gas-pair selectivity. On the other hand, the smallest H₂ molecules can still manage to diffuse through easily and hence, selectivity for H₂/N₂ and H₂/CO₂ increases monotonically with the UV irradiation time.

In accordance with the present disclosure, the UV-rearranged PIM-1 membranes of the present disclosure can exhibit a considerable reduction in gas permeability and at the same time can exhibit a radical increase in the diffusivity selectivity of H₂/CO₂, thereby resulting in a continuous improvement in H₂/CO₂ selectivity with increasing UV irradiation time. This reduction in gas permeability and increase in diffusivity selectivity can be somewhat verified by the sorption results shown in Table 2. As discussed previously, the reduction in gas permeability along with increasing UV irradiation time mainly results from the decreased diffusivity ability of gas molecules due to the reduced pore size and reduced FFV in the UV-irradiated PIM-1 membranes of the present disclosure. Using CO₂ and CH₄ sorption data in Table 2 as examples, the different UV irradiation times can have little effect on the solubility selectivity of CO₂/CH₄; thus, the enhanced gas-pair selectivity can be the result of the increased diffusivity selectivity of CO₂/CH₄. The highest diffusivity selectivity of CO₂/CH₄ can be seen in the 30 min UV-irradiated PIM-1 membrane (i.e., PIM-UV30min). UV irradiation longer than 30 min can lead to a reduced diffusivity selectivity for CO₂/CH₄. This can be accounted for by the reduced membrane pore size that no longer effectively discriminates CO₂ molecules over CH₄ molecules; rather both molecules can have almost the same difficulties and same diffusion rates across the membrane.

Mixed Gas Separation Performance and the Upper Bound Comparison

Mixed gas tests were conducted for embodiments of a UV-irradiated PIM-1 membrane of the present disclosure at 35° C. and the results are summarized in Table 3. The embodiments of a UV-irradiated PIM-1 membrane of the present disclosure used for mixed gas testing include PIM-UV20min (20 minute UV-irradiated PIM-1 membrane); PIM-UV30min (30 minute UV-irradiated PIM-1 membrane); PIM-UV2hr (2 hour UV-irradiated PIM-1 membrane); and PIM-UV4hr (4 hour UV-irradiated PIM-1 membrane).

TABLE 3
Mixed gas separation performance of the UV-irradiated
PIM-1 membranes (Tested at 35° C. and 7.0 atm)^{a)}

| | Permeability | | | | |
|---|---|---|---|---|---|
| | [Barrer]^{b)} | | | Selectivity | |
| Membrane | H₂ | CH₄ | CO₂ | H₂/CO₂ | CO₂/CH₄ |

Mixed gas with feed composition of H₂/CO₂: 50/50%

| | | | | | |
|---|---|---|---|---|---|
| PIM-UV2 hr | 293 (553)^{c)} | — | 62.4 (118) | 4.7 (4.7)^{c)} | — |
| PIM-UV4 hr | 265 (452) | — | 37.2 (61.9) | 7.1 (7.3) | — |

Mixed gas with feed composition of H₂/CO₂/CO: 50/49/1.0%

| | | | | | |
|---|---|---|---|---|---|
| PIM-UV2 hr | 294 | — | 61.1 | 4.7 | — |
| PIM-UV4 hr | 264 | — | 36.5 | 7.3 | — |

Mixed gas with feed composition of CO₂/CH₄: 50/50%

| | | | | | |
|---|---|---|---|---|---|
| PIM-UV20 min | — | 61.3 (62.1) | 1554 (1869) | — | 25.4 (30.1) |
| PIM-UV30 min | — | 20.4 (23.1) | 724 (745) | — | 29.3 (31.3) |

Mixed gas with feed composition of CO₂/CH₄/H₂S: 50/49.95/0.05%

| | | | | | |
|---|---|---|---|---|---|
| PIM-UV20 min | — | 82.6 | 745 | — | 9.1 |
| PIM-UV30 min | — | 33.7 | 367 | — | 10.9 |

^{a)}(All UV-treatment or UV-irradiation of PIM-1 membranes were carried out at a fixed UV distance of 2 cm and UV wavelength of 254 nm);
^{b)}(1 Barrer = 1 × 10⁻¹⁰ cm³(STP) cm cm⁻² s⁻¹ cmHg⁻¹);
^{c)}(Number in parentheses is the permeability and ideal selectivity tested by pure gases)

Typically, the gas permeability in mixed gas tests is lower than that in pure gas tests mainly due to the undesirable competitive sorption between the two gases. Considering the possible minor contaminants of CO in hydrogen enrichment processes and H₂S in natural gas streams, both components in a reasonable amount were also included in the mixed gas tests. Referring to tertiary H₂/CO₂/CO tests, the addition of 1.0 wt % CO can have little effect towards H₂/CO₂ separation. Referring to tertiary H₂/CO₂/CO tests, the addition of 0.05 wt % H₂S in the CO₂/CH₄ mixture can significantly alter both gas permeability and selectivity. There can be an approximate 50% decrease in CO₂ permeability and a two-fold decrease in CO₂/CH₄ selectivity in the tertiary CO₂/CH₄/H₂S test when compared to the binary CO₂/CH₄ test. This may be caused by the sorption and plasticization effects of the highly condensable H₂S gas that may cause the PIM-1 polymer matrix to swell, leading to the increased permeability of the slower gas (i.e., CH₄) and reducing selectivity. The pronounced competitive sorption between H₂S and CO₂ also can result in a substantial decrease in CO₂ permeability. The decreased gas permeability of H₂ and CO₂ in the mixed gas tests compared to the pure gas tests can be ascribed to the effect of the competition in permeation between H₂ and CO₂. In other words, in the mixed gas tests, the diffusion can favor the permeation of H₂, whereas the sorption can favor the permeation of CO₂. As a result, the competition in permeation between H₂ and CO₂ can reduce gas permeability in mixed gas tests.

In embodiments, the UV-treatment or UV-irradiation of PIM-1 membranes can be performed using UV-generating equipment. In embodiments, the PIM-1 membranes can be sandwiched in between two quartz plates and kept a fixed UV distance away from a UV-bulb for a period of time. Other methods of performing UV-treatment or UV-irradiation are also contemplated.

In embodiments, UV-treatment or UV-irradiation of PIM-1 membranes can be carried out at a fixed UV distance of about 2 cm and UV wavelength of about 254 nm. In embodiments, UV-treatment or UV-irradiation can be carried out at a UV wavelength less than about 254 nm. In embodiments, UV-treatment or UV-irradiation can be carried out at a UV wavelength greater than about 254 nm. In embodiments, UV-treatment or UV-irradiation can be carried out at a UV distance of less than about 2 cm. In embodiments, UV-treatment or UV-irradiation can be carried out at a UV distance of greater than about 2 cm. In embodiments, UV distance and/or UV wavelength can be variable (i.e., are not fixed) during UV-treatment or UV-irradiation.

In embodiments, UV-treatment or UV-irradiation of PIM-1 membranes can be carried out for about 1 minute or more, about 5 minutes or more, about 10 minutes or more, about 30 minutes or more, about 1 hour or more, about 1.5 hours or more, about 2 hours or more, about 2.5 hours or more, about 3 hours or more, about 3.5 hours or more, or about 4 hours or more.

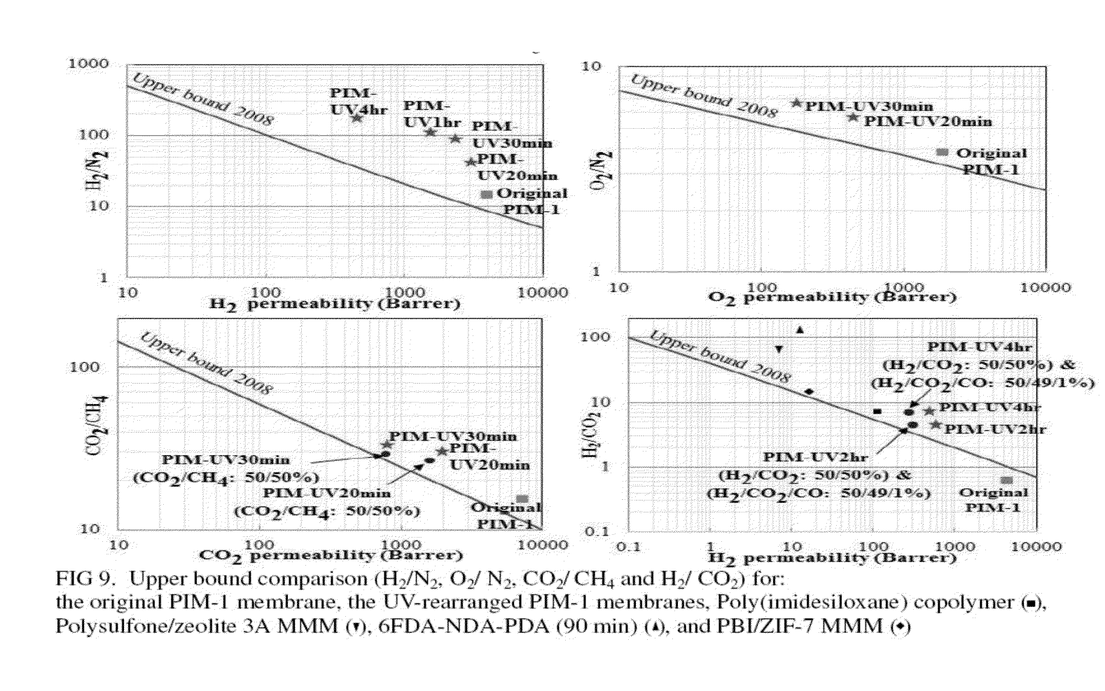

FIG. 9 shows the gas separation performance of the UV-irradiated PIM-1 membranes of the present disclosure in comparison with the latest Robeson's upper bound. As can been seen from FIG. 9, the UV-irradiated PIM-1 membranes demonstrate exceptional gas separation performance, surpassing the most recent upper bound of conventional and state-of-the-art polymeric membranes for the important gas pairs, such as, H₂/N₂, O₂/N₂, CO₂/CH₄ and H₂/CO₂. Importantly, to the best of the inventors' knowledge, the H₂/CO₂ separation performance of the UV-irradiated PIM-1 polymeric membranes of the present disclosure can outperform all known polymeric membranes, especially in terms of H₂ permeability. Additionally, both the binary and tertiary gas separation performance of the UV-irradiated PIM-1 polymeric membranes of the present disclosure also surpass the upper bound line for H₂/CO₂ separation, which strongly suggests that the UV-rearranged PIM-1 membranes can be used in industrial hydrogen enrichment processes.

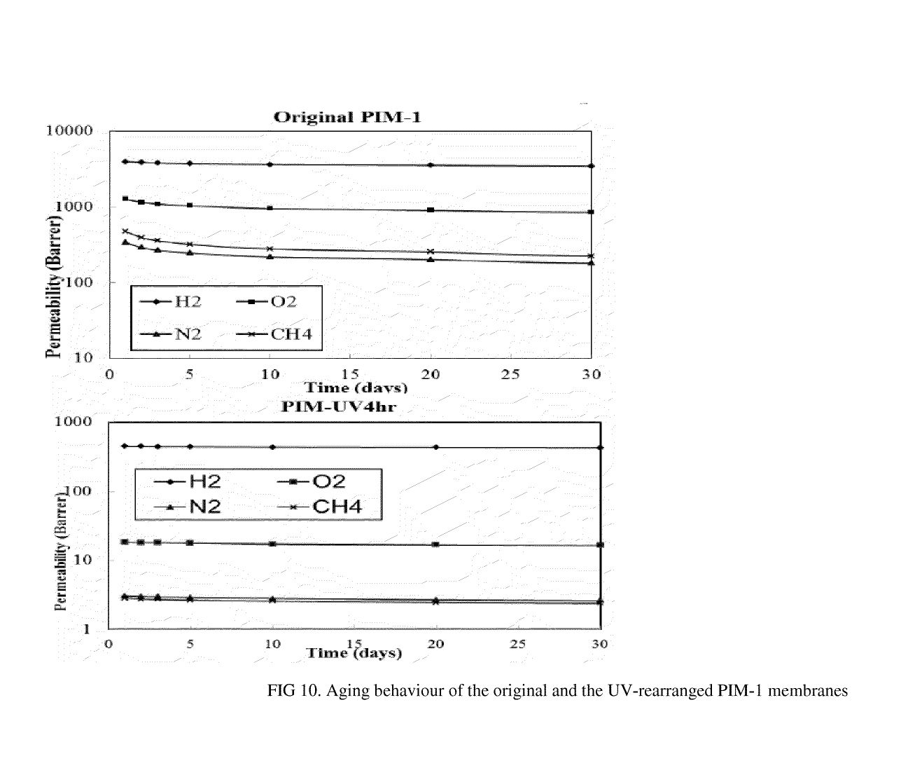

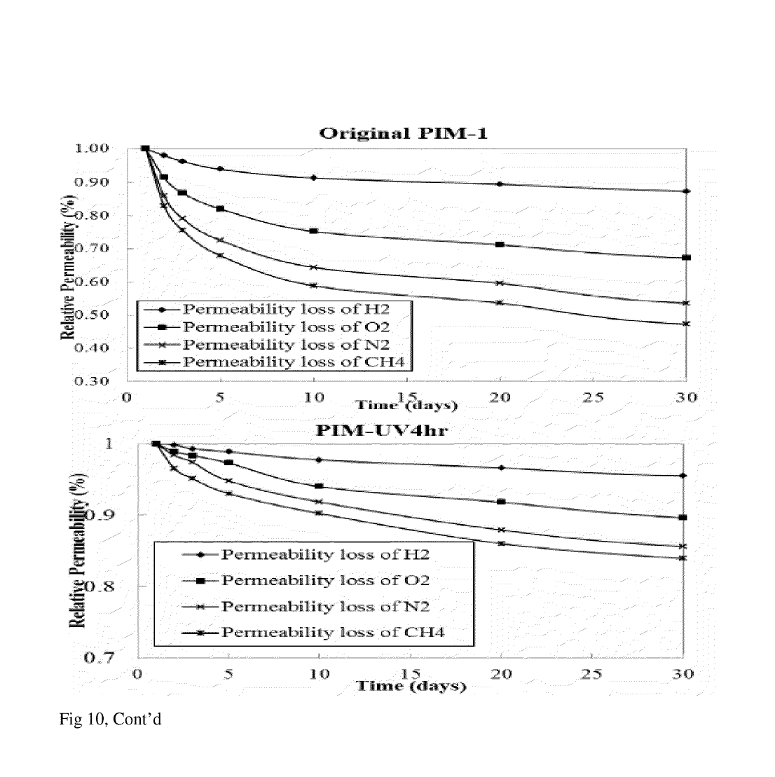

Considering the strong desire of long-term stability tests for industrial use, the physical aging behavior of the selected UV-rearranged PIM-1 membranes can be monitored. FIG. 10 illustrates the ageing behavior of an original PIM-1 membrane and a UV-rearranged PIM-1 membrane (in this case PIM-UV4hr) of the present disclosure. As can be seen in FIG. 10, the UV-rearranged PIM-1 membrane shows much better membrane stability compared to the original PIM-1 membrane. This again boosts the potential applicability of the UV-rearranged PIM-1 membranes for industrial uses.

The present disclosure also relates to a method of separating a gas mixture, wherein the method includes: providing a UV-irradiated or UV-rearranged PIM-1 membrane of the present disclosure and directing a gas mixture through the UV-irradiated or UV-rearranged PIM-1 membrane of the present disclosure.

In embodiments, the method of separating a gas mixture can include providing one or more UV-irradiated or UV-rearranged PIM-1 membranes of the present disclosure and directing a gas mixture through the one or more UV-irradiated or UV-rearranged PIM-1 membranes of the present disclosure.

In embodiments, the method of separating a gas mixture can include providing one or more UV-irradiated or UV-rearranged PIM-1 membranes of the present disclosure and contacting a gas mixture with the one or more UV-irradiated or UV-rearranged PIM-1 membranes of the present disclosure.

In embodiments, the method of separating a gas mixture can be performed on an industrial scale. Equipment for separating a gas mixture using the one or more UV-irradiated or UV-rearranged PIM-1 membranes of the present disclosure on an industrial scale is contemplated.

In an embodiment, the method of separating a gas mixture can include the use of one or more UV-irradiated or UV rearranged PIM-1 membranes of the present disclosure in combination with one or more other types of membranes used for separating gas mixtures.

In embodiments, the gas mixture can include H₂/CO₂, H₂/CO₂/CO, CO₂/CH₄, CO₂/CH₄/H₂S, H₂/N₂, O₂/N₂ or a combination thereof.

In accordance with the present disclosure, PIM-1 membranes can be successfully modified to form UV-rearranged PIM-1 membranes or dense films (i.e., UV-irradiated PIM-1 membranes or dense films). The PIM-1 backbone can undergo homolytic cleavage at the C—H bond and an intra-molecular 1,2-migration reaction to form the UV-rearranged PIM-1 (i.e., UV-irradiated PIM-1) of the present disclosure via a photochemical reaction. The kinked nature of the original PIM-1 is destructed during the photochemical reaction to form the UV-rearranged PIM-1 of the present disclosure wherein the destruction of the kinked nature of the original PIM-1 results in a substantial decrease in both FFV and pore size. The original PIM-1 exhibits extremely high gas permeability, which is mainly ascribed to the contorted nature that induces excess free volume in the polymer matrix. After the UV irradiation treatment, there is a comprehensible decrease in permeability due to the disturbed polymer chain backbone that results in the rearrangement of polymer chains, and thus a decrease in pore size and FFV in the polymer matrix. In light of the PAL results, a clear reduction in τ₃ value and sharpening of free volume distribution with an increase in UV irradiation time provides clear evidence for this. Therefore, the decrease in gas permeability can be attributed to the decrease in the diffusivity coefficient Likewise, the increase in gas-pair selectivity can be attributed to the increased diffusivity selectivity caused by the UV irradiation treatment. In general, the UV-irradiated PIM-1 membranes of the present disclosure demonstrate exceptional gas separation performance that surpasses the most recent upper bound of conventional and state-of-the-art polymeric membranes for the important gas pairs, such, as H₂/N₂, CO₂/CH₄ and H₂/CO₂. Particularly, to the best of the inventors' knowledge, the separation performance of H₂/CO₂ of the UV-irradiated PIM-1 membranes of the present disclosure may be the best compared to all known polymeric membranes. For example, in embodiments, the UV-rearranged PIM-1 membrane (i.e., PIM-UV4hr) can have a H₂ permeability of 452 barrer and an ideal H₂/CO₂ selectivity of 7.3. The newly developed UV-rearranged PIM-1 membrane of the present disclosure also shows stable mixed gas separation performance in the presence of CO; thus, in embodiments, the UV-rearranged PIM-1 membrane of the present disclosure can be used for industrial hydrogen enrichment processes.

### EXAMPLE

Materials: 5,5′,6,6′-tetrahydroxy-3,3,3′,3′-tetramethyl-1,1′-spirobisindane (TTSBI, 97%) purchased from Alfa Aesar, was recrystallized from methanol. 2,3,5,6-tetrafluoroterephthalonitrile (TFTPN, 99%) supplied by Sigma-Aldrich, was sublimated under vacuum prior to use. Anhydrous potassium carbonate (K₂CO₃, ≧99%) from Sigma-Aldrich and methanol (MeOH, ≧99.9%) from Merck were used as received. Dichloromethane (DCM, 99.99%) and hydrochloric acid (HCl, 37.5%) were obtained from Fisher Scientific and also used as received. N-Methyl-2-pyrrolidone (NMP, >99.5%) from Merck was further purified via distillation prior to use.

Synthesis of PIM-1 and dense membrane preparation: The synthesis of PIM-1 was based on polycondensation of TFTPN with TTSBI. A 2% (w/w) of polymer solution was prepared by dissolving readily-soluble PIM-1 powder in DCM. The polymer solution was filtered using a 1.0 μm Whatman's filter before ring casting onto a silicon wafer plate at room temperature (i.e., 25±2° C.) to allow slow evaporation of the solvent. Dense membranes or dense films were formed after approximately five days. The nascent dense films were then soaked in MeOH and dried in a vacuum oven at 120° C. to remove the residual solvent. PIM-1 membranes with the thickness of 55±5 μm were used for further studies/testing.

UV irradiation treatments: The UV irradiation treatments of PIM-1 membranes or dense films were performed using UV-generating equipment (Vilber Lourmat Corporation, Marne-la-vallée Cedex1, France, λ=254 nm). The PIM-1 membranes or dense films were sandwiched in between two quartz plates and kept 2 cm away from the UV-bulb (BLX-254 5×8 w−254 nm) for a period of 10 min to 4 hr. After the UV irradiation treatment process, the membranes were stored in a dry box prior to permeation and characterization studies. The UV-treated PIM-1 membrane dense films were labeled as “PIM-UV-duration”, for example, PIM-UV10min.

Characterizations: The ordered dimension and inter-chain spacing of various membranes were investigated by XRD (D8 series, general area detector diffraction system (GADDS), Wisconsin, USA) at ambient temperature. In the test, Ni-filtered Cu Kα with a radiation wavelength λ=1.54 Å was used. The average d-space was evaluated based on Bragg's law as shown in Equation (1):

nλ=2d sin θ (1)

where n is an integer (1, 2, 3, . . . ), λ denotes the X-ray wavelength, d represents the inter-segmental spacing between two polymer chains and θ stands for the X-ray diffraction angle of the peak.

The PAL experiments were conducted for both the pristine original PIM-1 and the UV-irradiated PIM-1 membranes using a variable-energy positron beam with a counting rate of 100-500 counts s⁻¹ and wherein each spectrum contains one million counts. In PAL measurements, the quantitative information of free-volume size, distribution and content is mainly ascribed to the so-called pick-off annihilation of long-lived ortho-Positronium (o-Ps, the triplet bound state of a positron and an electron). The obtained PAL data were fitted into three lifetimes using the PATFIT program, which assumes a Gaussian distribution of the logarithm of the lifetime for each component. The MELT program was adopted to observe the trend for free volume distribution of various membranes.

Molecular Simulation: To examine the possible change in the structural alignment after the UV rearrangement process, both an original PIM-1 membrane and a UV-rearranged PIM-1 membrane were built by the amorphous cell based on compass force-field calculations. Each amorphous cell module consists of 4 polymer chains with 10 repeating units each. It was subjected to fine convergence with maximum iterations of 10,000 before proceeding with molecular dynamics simulation by the Discover module. The equilibrium stage temperature was set to 308K and 1 bar under isothermal-isobaric (NPT) mode. A total of 100,000 steps with a step size time of 1.0 fs and a dynamic time of 1000 ps were employed. The fractional free volume (FFV) was calculated by the Connolly task. The kinetic diameters of H₂ and CO₂ molecules were used as Connolly radii in the calculation.

Measurement of gas transport properties: The pristine original PIM-1 membrane or dense film and the UV-irradiated PIM-1 dense membranes were tested in both pure gas and mixed gas systems. The pure gas permeation properties were evaluated by a variable-pressure constant-volume method. Each pure gas was tested at 35° C. and 3.5 atm (i.e., 36.7 psia). The rate of pressure increase (dp/dt) at steady state was used for the calculation of gas permeability. The ideal selectivity of a membrane for pure gases A to B is defined as follows: α_{A/B}=P_{A}/P_{B}, where P_{A} and P_{B} are the pure gas permeability of gases A and B, respectively.

The mixed gas permeation properties for selected UV-rearranged PIM-1 membranes were obtained from a modified pure gas permeation cell. In detail, an additional valve at the upstream segment is included to adjust the stage cut and another valve at the downstream port is installed to introduce the accumulated permeate gas to an Agilent 7890 gas chromatography (GC) for the analysis of the gas composition. To avoid the possible concentration polarization in the upstream segment, the stage cut (i.e., ratio of permeate flow over feed flow) was always controlled at less than 5%. This was achieved by adjusting the retentate flux during the mixed gas test. Both CO₂/CH₄ mixture (50%/50% mole fraction) and H₂/CO₂ mixture (50%/50% mole fraction) were used in the mixed gas tests and they were carried out at 35° C. and 7 atm (i.e., 88.2 psia) for easy comparison with pure gas tests. In considering the possible industrial applications, small amounts of hydrogen sulfide (i.e., H₂S) and CO were also included into the mixed gas tests of CO₂/CH₄ (i.e., CO₂/CH₄/H₂S: 50/49.95/0.05%) and H₂/CO₂ (i.e., H₂/CO₂/CO: 50/49/1.0%), respectively. However, due to the detection limitation of the GC used, the exact amounts of H₂S and CO in the permeate side were not calculated.

The physical aging behavior of the original PIM-1 membrane and the UV-irradiated PIM-1 membranes (in this case PIM-UV4hr) were preliminarily studied through a period of 30 days. H₂, O₂, N₂ and CH₄ were used in the aging tests. However, CO₂ was not used due to its high solubility in glassy polymers that may alter the nature of the glassy state. All PIM-1 membranes used in the aging study had a thickness of 55±5 μm.

Measurement of gas sorption properties: Both CH₄ and CO₂ sorption tests were performed for the pristine original PIM-1 membrane and the UV-irradiated PIM-1 membranes using the gravimetric sorption technique (Cahn D200 microbalance sorption cell). The tests were conducted from a pressure range of 0-30 atm at 35° C. and approximately 80 mg of each sample was loaded for the experiment. The sorption cell was evacuated under vacuum for at least 24 hr prior to the test. The gas at a specific pressure was introduced into the system and the sample then started adsorbing the gas until the equilibrium was reached. The gas sorption ability of the sample was calculated based on the weight gain with consideration of buoyancy force. To minimize the possible error introduced due to the high aging rate in PIM-1 based membranes, fresh membrane samples were used each time during a single gas test and it took 2 days for each sorption test. Once the solubility coefficient (i.e., S) for a specific gas was obtained through the sorption study, the diffusivity coefficient (i.e., D) was calculated based on P=DS.

In summary, for the first time, the inventors of the present disclosure have discovered that UV-rearranged polymers of PIM-1 membranes can be used for H₂/CO₂ separation with far superior separation performance compared to other polymeric membranes known in the art. For example, in embodiments, the PIM-1 membrane after UV radiation for 4 hours can show a H₂ permeability of about 452 barrer and a H₂/CO₂ selectivity of about 7.3. Experimental data and molecular simulation reveal that the polymer chains of PIM-1 can undergo a 1,2-migration reaction and transform to a close-to-planar like rearranged structure after UV radiation. As a result, the UV-irradiated PIM-1 membrane of the present disclosure can exhibit a considerable decrease in both the fractional free volume (FFV) and size of micro-pores. Nuclear magnetic resonance (NMR) and positron annihilation lifetime (PAL) results have been used to confirm the chemical and structural changes in PIM-1 after UV radiation, indicating that the decrease in both the FFV and size of micro-pores can be mainly ascribed to the destructed spiro-carbon center that results from the exposure to UV radiation.

In contrast to an unmodified PIM-1, the UV-irradiated PIM-1 membranes of the present disclosure can exhibit exceptionally high gas separation performance that surpass the upper bounds for gas pairs such as H₂/N₂, CO₂/CH₄ and H₂/CO₂. Sorption and x-ray diffraction (XRD) analyses indicate that the impressive H₂/CO₂ selectivity can arise from the significantly enhanced diffusivity selectivity induced by UV radiation, followed by molecular rearrangement, conformation change and more efficient polymer chain packing. The UV-irradiated PIM-1 can exhibit better polymer chain packing and a smaller fractional free volume (FFV) compared to the unmodified PIM-1. In addition, compared to pure gas tests, the UV-irradiated PIM-1 membrane can exhibit stable and comparable separation performance in mixed gas tests with and without the presence of CO. Therefore, the newly discovered UV-rearranged PIM-1 membrane may have great potential for the purification and production of industrial hydrogen.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

### REFERENCES

N. Du, G. P. Robertson, J. Song, I. Pinnau, M. D. Guiver, Macromolecules 2009, 42, 6038.

C. R. Mason, L. Maynard-Atem, N. M. Al-Harbi, P. M. Budd, P. Bernardo, F. Bazzarelli, G. Clarizia, J. C. Jansen, Macromolecules 2011, 44, 6471.

1. A material comprising a monomer, wherein the monomer comprises a monomer formula:

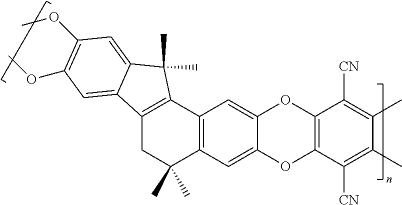

2. The material of claim 1, wherein the material comprises a membrane, wherein the membrane comprises the monomer.

3. The material of claim 2, wherein the material can be used for separation of a gas mixture selected from the group of gas mixtures consisting of H₂/CO₂, H₂/CO₂/CO, CO₂/CH₄, CO₂/CH₄/H₂S, H₂/N₂ and O₂/N₂.

4. A process of preparing the material of claim 1, comprising:
(a) providing an organic polymeric material containing a micro-porous structure and polymer chains; and
(b) performing ultraviolet (UV) irradiation on the organic polymeric material to form a UV irradiated organic polymeric material.

5. The process of claim 4, further comprising:
(c) performing a homolytic cleavage reaction on C—H bonds selected from the group of intra-molecular C—H bonds of the UV irradiated organic polymeric material, intermolecular C—H bonds of the UV irradiated organic polymeric material and a combination thereof.

6. The process of claim 5, wherein the micro-porous structure of the organic polymeric material comprises large micro-pores and ultrafine micro-pores, wherein the large micro-pores are due to the contorted or rigid nature of the organic polymeric material.

7. The process of claim 6, comprising destructing the micro-porous structure of the organic polymeric material.

8. The process of claim 7, comprising rearranging the polymer chains of the organic polymeric material.

9. The process of claim 8, wherein the destructing of the micro-porous structure and the rearranging of the polymer chains results in efficient polymer chain packing and the formation of a rearranged organic polymeric material.

10. The process of claim 4, wherein the UV irradiation is provided by a UV wavelength of 254 nm.

11. The process of claim 10, wherein the UV irradiation is provided for a period of time selected from the group consisting of about 10 minutes, about 20 minutes, about 30 minutes, about 1 hour, about 2 hours, and about 4 hrs.

12. The process of claim 5, wherein the homolytic cleavage reaction is provided by a 1,2-migration reaction to form a cyclohexyl ring.

13. The process of claim 9, wherein the destruction of the microporous structure and the formation of the rearranged organic polymeric material comprises a reaction formula:

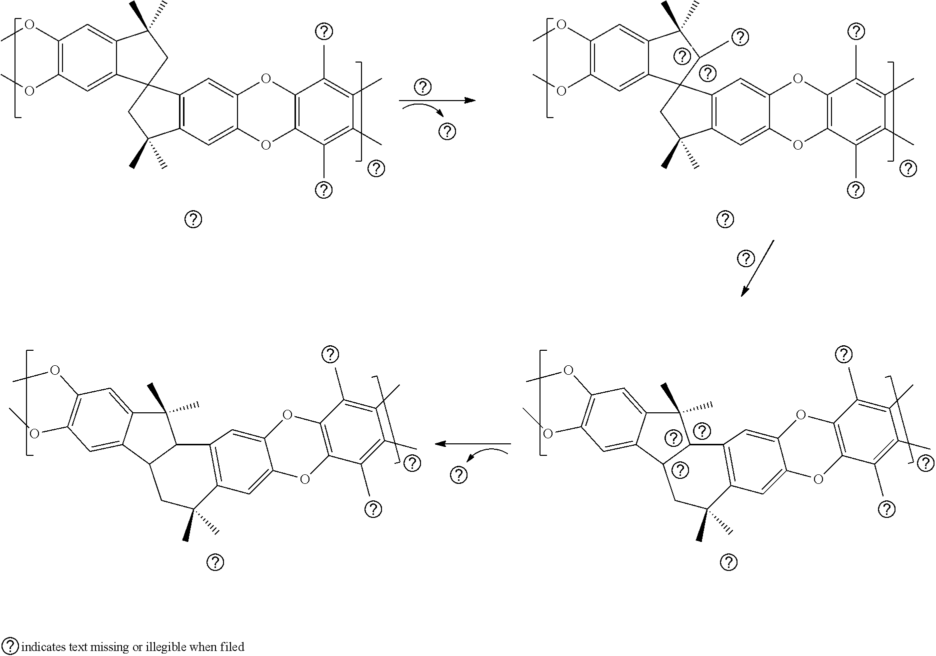

14. A method of separating a gas mixture, comprising:
(a) providing the material of claim 1; and
(b) contacting the gas mixture with the material.
